(19) United States
(12) Patent Application Publication
(10) Pub. No.: US 2009/0083710 A1
(43) Pub. Date: Mar. 26, 2009

(54) SYSTEMS AND METHODS FOR CREATING, COLLABORATING, AND PRESENTING SOFTWARE DEMONSTRATIONS, AND METHODS OF MARKETING OF THE SAME

(75) Inventors: Eric T. Best, Seattle, WA (US); Christopher R. Peterson, Seattle, WA (US); Rajendra Dodhiawala, Bellevue, WA (US); Timothy P. Goggin, Seattle, WA (US); Mark Purcell, Seattle, WA (US); Evan Vernon, Seattle, WA (US); Brandon Adams, Auburn, WA (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: Morse Best Innovation, Inc., Seattle, WA (US)

(21) Appl. No.: 11/869,574

(22) Filed: Oct. 9, 2007

Related U.S. Application Data
(60) Provisional application No. 60/974,373, filed on Sep. 21, 2007.

(51) Int. Cl. G06F 9/44

(52) U.S. Cl. 717/120

(57) ABSTRACT

A software demonstration may be created by capturing screenshots of normal use of an application. The authoring tool may capture a screenshot upon detecting an input. Before capturing the screenshot, the authoring tool may delay for a pre-determined and/or user-configurable period of time to allow the computer display to be refreshed. The authoring tool may provide a cue to inform the user of the timing of the screenshot acquisition. If a screenshot is mistimed, it may be replaced without interrupting the flow of the software demonstration. Screenshots may be linked to one another using clickable hotspots. The hotspots may be used in presenting the software demonstration to provide for a realistic presentation of a software product. The authoring tool may publish the software demonstration in a web accessible format to a network accessible storage location to allow reviewers to comment on the demonstration. An author may access the presentation to review commentary on the demonstration. A software demonstration may be published as a distributable file which may comprise the software demonstration, a player to allow a recipient to view the demonstration, and a version of the software demonstration tool to virally create marketing opportunities for the authoring tool.

### RELATED APPLICATIONS

This application claims priority to U.S. Provisional Application 60/973,373 entitled SYSTEM AND METHOD FOR CREATING, COLLABORATING, AND PRESENTING SOFTWARE DEMONSTRATIONS, AND METHODS OF MARKETING OF THE SAME, filed on Sep. 21, 2007.

### TECHNICAL FIELD

This disclosure relates generally to an authoring and collaboration tool for software demonstrations and specifically to a system and method for creating, sharing, and presenting software demonstrations and for viral marketing methods of the same.

### BACKGROUND

Creating, sharing and presenting demonstrations of complex software products can be a difficult and expensive task for some organizations. This may be because the software product to be demonstrated may be complex, require network interaction and setup, or may require significant system resources not available on a typical salesperson's computer. As such, what is needed is a system and method to easily create lifelike and realistic software demonstrations that may be presented on a typical salesperson's computer without the need for extensive setup.

### BRIEF DESCRIPTION OF THE DRAWINGS

FIG. 1 depicts an exemplary desktop of a computing device;

FIG. 2 depicts an exemplary desktop of a computing device having a graphical cue overlaid thereon;

FIG. 3a depicts one embodiment of a block diagram of a software demonstration authoring application running on a computer system;

FIG. 3b is a flow diagram depicting a processing method for providing a cue to a user and replacing a software demonstration screenshot according to the teachings of this disclosure;

FIG. 4 depicts an exemplary display area of a computing device, illustrating a tool-tip hover effect;

FIGS. 5a, 5b, and 5c depicts an exemplary application screenshot capture having a branching condition;

FIGS. 6a and 6b depict a sequential screenshot sequence and branching screenshot sequence respectively;

FIG. 7 depicts a software demonstration editing interface;

FIG. 8a depicts one embodiment of a block diagram of a software demonstration presentation application running a computer system;

FIG. 8b depicts an embodiment of a software demonstration presentation;

FIG. 9 depicts an embodiment of a presentation of a training mode software demonstration;

FIG. 10a depicts and embodiment of a block diagram of a system for facilitating collaboration on a software demonstration;

FIG. 10b is a flow diagram of a method for collaboration on a software demonstration;

FIG. 11 depicts an embodiment of a web interface displaying a software demonstration packaged for on-line review;

FIG. 12 depicts an embodiment of a web interface displaying a software demonstration with reviewer comments;

FIG. 13a is an embodiment of a block diagram of a distributable file used to virally create marketing opportunities for an authoring tool; and

FIG. 13b is a flow diagram of a viral marketing method for a software demonstration creation, presentation, and collaboration system.

### DETAILED DESCRIPTION OF THE PREFERRED EMBODIMENTS

This disclosure describes a software demonstration system and method comprising several components, including: a software demonstration creation and editing tool, a software demonstration player, and a software demonstration distribution and collaboration portal. Each of these components are described herein.

In one embodiment, the demonstration creation software may comprise a software demonstration authoring and editing component comprising a user interface. The user interface of the software demonstration authoring and editing component may provide an input allowing a user to begin recording or capturing a software demonstration. This process is described in detail below.

Upon the user's selection of this input, the software demonstration authoring user interface may cause a dialog box to appear, informing the user that the computer desktop should be prepared for creating the software demonstration. Preparing a computer desktop for a software demonstration may comprise changing the display resolution, removing unused or distracting icons, and the like. This is because the software demonstration creation tool of this disclosure may record a software demonstration by capturing one or more screenshots of portions of user's computer desktop area. The screenshots may depict an operating state of the computer (e.g., one or more applications running on the computer, operating system effects such as tool times, or the like). As such, the user may wish to clear the desktop area of any unused or potentially distracting items before creating the software demonstration to prevent such items from becoming part of the software demonstration. The user may also wish to modify the computer display resolution to determine the size of the resulting screenshots. As used herein, a screenshot may be an image of a computer display area comprising the entire viewable area of a computer display or a portion of the viewable area of a computer display (e.g., an application window displayed on a computer display). In addition, a screenshot as used herein, may be used to reflect the operating state of the computer. As used herein, an operating state of a computer may comprise depicting the contents of the display of the computer including the desktop, any application(s) running on the computer, any operating system effects displayed by the computer (e.g., highlighting of input fields, tool-tips, or the like), any audio video playing on the computer, and the like.

After preparing the desktop and directing the user interface to begin recording, the demonstration authoring user interface may be hidden from view. The demonstration tool may be so hidden to avoid cluttering the desktop and to prevent the tool from being displayed in the authored software demonstration to allow the software demonstration to more accurately and/or realistically capture an operating state of the computer.

Although the user interface of the authoring tool may be hidden from view, the demonstration authoring software may continue to run. The authoring program may capture user input actions and create the software demonstration responsive to the input. In this way, the authoring software may allow the user to create a software demonstration as she naturally uses the software.

In one embodiment, the demonstration authoring software may detect user input, such as a mouse button click. This input may be detected because it is the input typically used to invoke programs, select program menu items, and the like. However, it should be understood that computer users may assign any number of different inputs to perform these functions, such as alternative mouse buttons, keyboard keys, pointing devices, and the like. The demonstration authoring tool of this disclosure could be configured to detect any such input. As such, although the disclosure refers to the detection of a mouse button for clarity and consistency, it is not limited to only detecting such input.

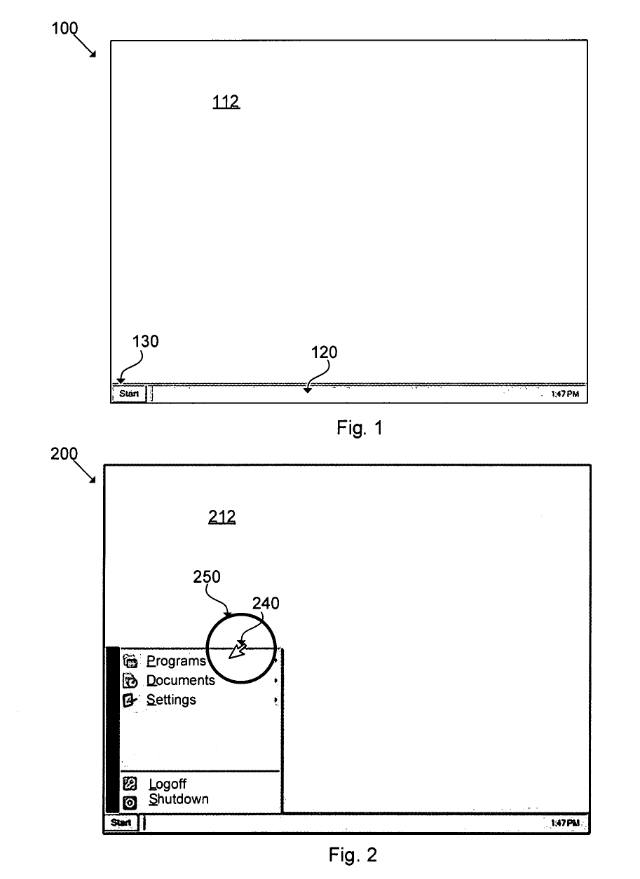

Upon detecting a mouse button click, the authoring software may acquire one or more screenshots. For example, FIG. 1, shows a computer desktop 100 having a viewable area 112 that may represent a screenshot comprising the entire viewable area of a computer display. In the FIG. 1 embodiment, which may be a computing device having a display running Microsoft® Windows, a screenshot may comprise the entire desktop area including the taskbar 120, “Start” menu item 130, and any open applications. However, this disclosure should not be limited to screenshots comprising the entire viewable area of a flat 2-D displays as shown in FIG. 1. The teachings of the disclosure could be used to capture portions of the viewable area of a 2-D display or alternative display mechanisms such as 3-D displays, virtual reality displays, and the like. Similarly, this disclosure should not be read as limited to any particular computing platform and/or operating system. The teachings of this disclosure could be practiced using a wide variety of computing platforms including personal digital assistants (PDAs), smart phones, tablet computers, notebook computers, and the like. Moreover, the teachings of this disclosure may be practiced with in any operating system environment including, but not limited to, Linux, Unix®, Apple® OS X, and the like.

Upon detecting a mouse button click, a first screenshot may be acquired. This first screenshot may show the state of the display before the operating system and/or application responds to the mouse button click. For example, if the mouse button were clicked on the Microsoft® Windows “Start” menu, which typically causes the “Start” menu to expand, the first screenshot may display the desktop with the “Start” menu in its un-expanded state as shown in FIG. 1.

After obtaining the first screenshot, the demonstration authoring software may acquire a second screenshot. The second screenshot may be used to show the state of the display after the operating system and/or application has responded to the user input. In one embodiment, the second screenshot may be acquired after a pre-determined delay period. This delay period may allow the operating system and/or application sufficient time to receive the user input, process it, and update and/or refresh the display. From the above example, where the user input comprises selecting the Microsoft® Windows “Start” menu, the second screenshot may show the desktop with the “Start” menu in its expanded state.

This delay period may vary depending upon the responsiveness of the system. As used herein, system responsiveness may refer to how long it takes the operating system and/or application to respond to user input, including how long it takes the operating system and/or application to update the display responsive to user input.

System responsiveness may vary depending upon the computer running the demonstration software. The computer's central processing unit (CPU) operating frequency and/or architecture, video card, memory, and the like may affect the computer's responsiveness. Additionally, the nature of the application being demonstrated may affect responsiveness. For instance, a complex and/or network-based application may be less responsive due to its processing requirements and/or network latency, whereas a relatively simple application requiring only local processing may be more responsive. As such, the demonstration authoring system may allow the user to adjust the screenshot delay period according to the computing system used and the software being demonstrated.

In one embodiment, the demonstration authoring software may provide the user with a cue indicating the time the second screenshot was acquired. Such a cue may be visual, auditory, and/or tactile. As used herein a cue may any sensory signal used to prompt to user. A cue may comprise an on-screen graphic, such as an icon superimposed and/or overlaying the mouse pointer icon, a dialog box, a tool-tip, and the like. The cue may comprise audio, an external light source, or tactile feedback, such as a “rumble” found in some gaming controllers. FIG. 2 depicts one embodiment a desktop 200 having a graphical cue 250 superimposed upon pointer 240. In the FIG. 2 embodiment, graphical cue 250 may be displayed as the second screenshot is acquired and may remain displayed as shown in FIG. 2 for a short period of time.

The cue, such as graphical cue 250, may enable the software demonstration author to know when the second screenshot was acquired and, in particular, whether the screenshot was obtained at the right time. As discussed above, due to operating system and/or application latency, the demonstration authoring software may wait for a pre-determined period before acquiring screenshots following user input to allow the operating system and/or application sufficient time to update the computer display. If this delay is insufficient to allow the operating system and/or application to fully update the display, the screenshot may not accurately reflect the next step in the demonstration (i.e., the screenshot may be the same as the proceeding screenshot or may be incomplete). However, since the demonstration authoring software provides the user with a cue indicating the time the second screenshot is acquired, the author may immediately be made aware of the problem and respond to it.

In one embodiment, the demonstration authoring software may provide an additional user input to allow the demonstration author to replace the last screenshot taken with a new screenshot. This input may be associated with a key combination unlikely to interfere with the normal operation of the computer (e.g., a left or right ‘Ctrl’ key, or some other function-key combination). This feature may be used to replace a screenshot taken prematurely due to, inter alia, operating system and/or application latency. The demonstration author may be made aware of a possible problem with a screenshot due to the cue described above. For instance, if the author sees, hears, or feels the cue before the system has been refreshed, the author may know that the screenshot is likely to be premature and should be replaced. To remedy this problem without exiting the normal flow of creating the demonstration, the author may direct the demonstration authoring software to replace the screenshot after she sees that the display has been properly updated.

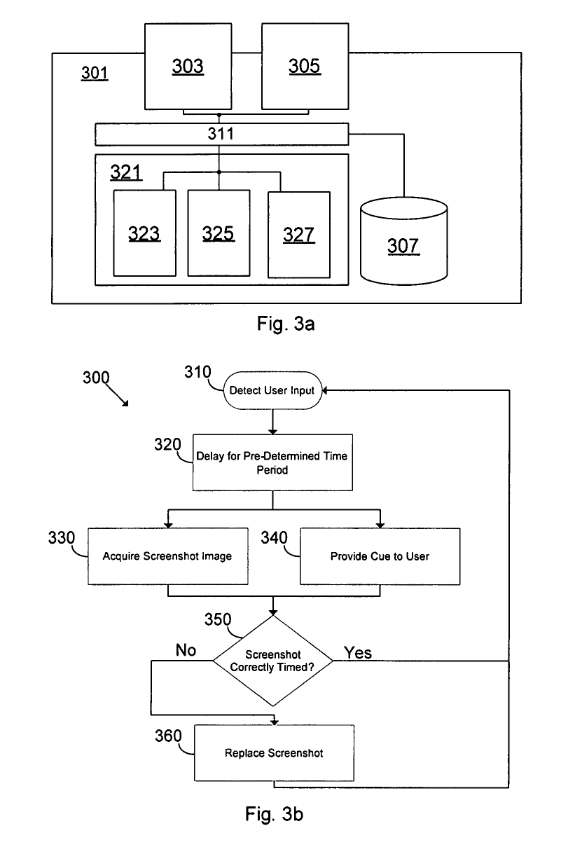

Turning to FIG. 3a, a block diagram of one embodiment of a software demonstration authoring program on a computer system 301 is depicted. The computer system 301 may comprise a display 303 and input device 305. Input device 305 may comprise a mouse pointer or any other pointing and/or selection device known in the art including, but not limited to, a mouse, track ball, touch pad, optical input, tactile input, or the like. Computer system 301 may comprise a data storage system 309.

Computer system 301 resources 303, 305, and 307 may be controlled and/or managed by operating system 311. Operating system 311 may be any operating system known in the art including, but not limited to Microsoft® Windows, Solaris®, Linux, Unix®, Apple® OS X, or the like.

Authoring application 321 may run on computer 301. Authoring application 321 may comprise a software demonstration authoring and/or editing application according to the teachings of this disclosure. Application 321 may comprise an input detection component 323, screenshot capture component 325, and screenshot ordering and storage component 327. Application 321 components 323, 325, and 327 may access the resources of computer system 301 via an application programming interface (API) provided by operating system 311.

The API provided by operating system 311 may allow input detection component 323 of application 321 to detect inputs to the computer 301 received via pointing device 305. The API may also allow authoring application 321 to determine the location and/or coordinates of the pointer of pointing device 305 on display 303. The API of operating system 311 may allow screen capture component 325 of authoring application 321 to capture the contents of display 303 as graphical image data. Finally, the API of operating system 311 may allow screenshot ordering and storage component 327 to store captured screenshot and related data in data storage system 309 of computer 301.

Turning to FIG. 3b, a flow diagram depicts a method 300 for providing a cue to a user and replacing a software demonstration screenshot according to the teachings of this disclosure. At 310, the software demonstration authoring system may detect a user input, such as, as discussed above, a mouse button click. At 320, the software demonstration authoring program may delay for a pre-determined period of time. This pre-determined time period may be set by the software author and may correspond to the expected display refresh latency of the software being demonstrated.

At step 330, the software demonstration authoring program may acquire a screenshot corresponding to a computer display area. As discussed above, the screenshot acquired at step 330 may comprise the entire displayable area of a computer display, or may comprise a portion of the displayable area of a computer display.

At step 340, the software demonstration authoring program may provide a cue to the user. In one embodiment, the cue of step 340 may be produced simultaneously with the acquisition of a screenshot of step 330. The cue provided at step 340 may comprise visual, audio, or tactile feedback, such as a graphic overlaying the computer display pointer, the playing of an audio track or cue, or a tactile rumble effect. The cue of step 340 may indicate the time the screenshot of step 330 was obtained.

At step 350, the user of the software demonstration authoring program, or the software demonstration program itself, may determine whether the screenshot of step 330 was properly timed. As discussed above, after receiving user input at 310, there may be delay in updating the computer display. Due to this delay, the screenshot obtained at step 330 may be improperly timed, meaning that it may be acquired before the computer display has properly refreshed. However, due to the cue provided at step 340, a user of the software demonstration authoring program may be made aware of the timing program at step 350. Alternatively, the software demonstration authoring program itself may determine that the screenshot was improperly timed. This determination may be made at step 350 and may comprise, comparing the screenshot image obtained at step 330 to a previously obtained screenshot, performing an image analysis on the screenshot image obtained at step 330 to detect un-refreshed portions of the computer display, detecting an additional screenshot image before additional user input is received at 310 to determine differences between the screenshot acquired at 330 and a subsequent screenshot image, or the like.

If the determination at step 350 indicates that the screenshot acquired at step 330 was properly timed, the flow may continue to step 310.

If the determination at step 350 indicates that the screenshot acquired at step 330 was not properly timed, the flow may continue to step 360. At step 360, a new screenshot may be obtained to replace the screenshot acquired at step 330. This screenshot may be obtained responsive to an input made by a user of the application. For example, as discussed above, the software demonstration program may provide an input to allow the user to replace the last screenshot acquired (the screenshot acquired at step 330), with a new screenshot. At step 360, the user may select this input, and replace the screenshot acquired at step 330 with a properly timed screenshot. Alternatively, if the software demonstration program itself determines at step 350 that the screenshot acquired at step 330 was mistimed, the software demonstration program may automatically replace the screenshot of step 330 with a new screenshot at step 360. Thereafter, the flow may continue at step 310.

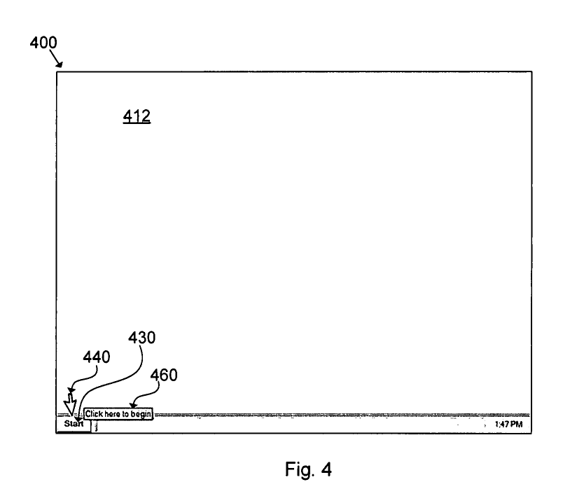

Turning now to FIG. 4, which depicts an exemplary display area of a computer device, including a tool-tip hover effect. In some cases, user interface components, such as icons, shortcuts, menu items, or the like may change their appearance when a pointing device is located on or near the item. Additionally, the operating system and/or application may cause a tool-tip to be displayed when a pointing device is located on or near the item. FIG. 4 depicts an exemplary computer desktop display area 412 including a tool-tip hover effect 460 that may appear when pointer 440 is placed near “Start” menu 430. These effects may be referred to as a “hover effect” since such effects are displayed when the mouse “hovers” near a particular user interface item. Other such hover effects may include changing the appearance of the “Start” menu button, playing an audio cue, and/or providing tactile feedback to a user.

The demonstration authoring tool may capture the hover effect(s) 460. In one embodiment, the authoring tool may provide an input to allow the demonstration author to capture this effect 460. This input may be associated with a key combination unlikely to interfere with the normal operation of the computer (e.g., a ‘Ctrl’ key, or some other function-key combination). The demonstration author may capture the hover effect by placing the mouse or pointer on the user input component to produce the effect and selecting the appropriate input. The demonstration authoring software may capture the hover effect and associate it with the previously captured screenshot so that it may be displayed as part of the demonstration as described below.

In one embodiment, the mouse button click (or other user input method) may be associated with a particular location on the screen. In other words, when the left mouse button click is detected, the demonstration authoring software may determine the position of the mouse cursor on the display. This position may be expanded to create a “Hotspot” on the screenshot. The expansion may comprise extrapolating a square, rectangle, circular, or like shape around the detected position of the mouse. Hotspots may be used when software demonstration is presented to make the demonstration appear more realistic and lifelike. When used in this manner, clicking the pointing device within a screenshot Hotspot may cause the software demonstration to advance to a following screenshot causing it to appear as if the software demonstration presenter is interacting with a “live” piece of software. The use of Hotspots is described in more detail below.

Using the authoring tool described above, an author may create a software demonstration by using the software to be demonstrated. During such use, the authoring tool may capture screenshots and pointer Hotspots corresponding to the use of the application.

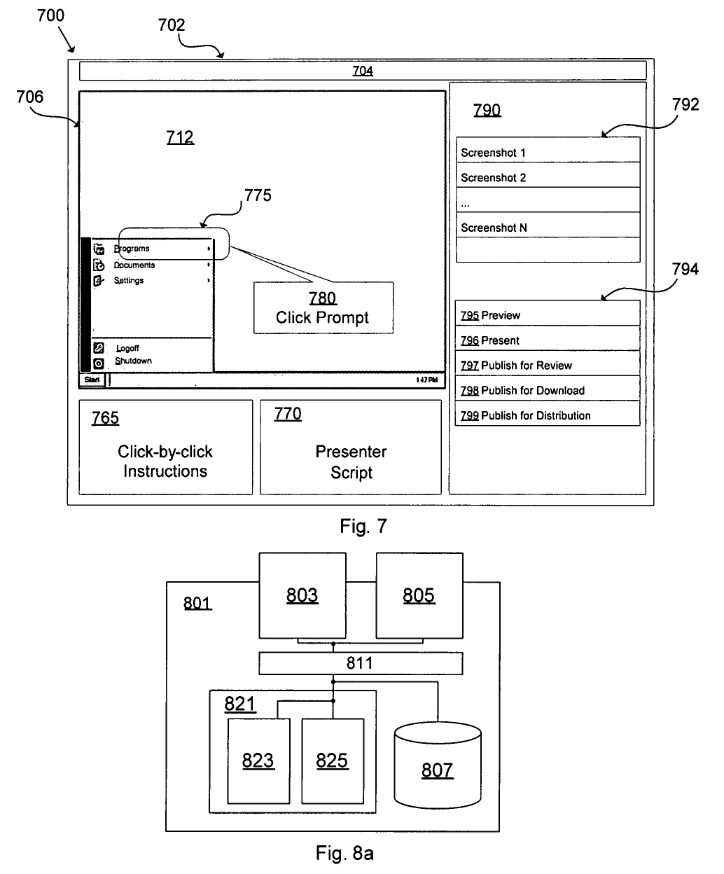

The authoring tool described above may provide an input to allow the author to stop the capture portion of software demonstration authoring, and to enter the software demonstration editor interface to edit the screenshots and/or Hotspots created during the capture processes. This input may be such that it will not interfere with the normal operation of the computer, such as the ‘esc’ key or some other function-key combination. Responsive to this input, the authoring tool may stop capturing screenshots and/or Hotspots and switch into the computer display foreground to display a software demonstration editing interface. A depiction of one embodiment of such an editing interface is shown in FIG. 7.

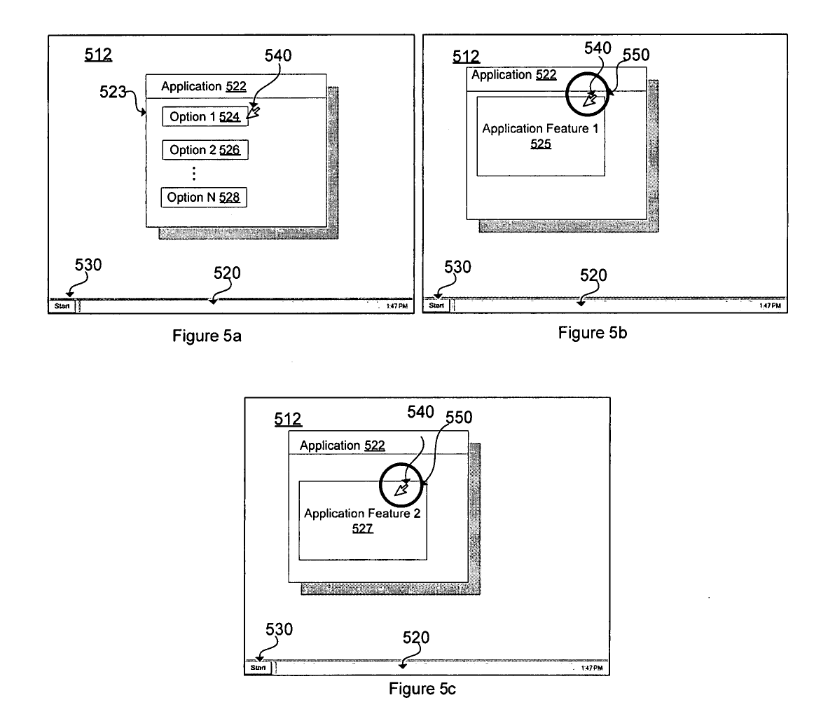

Turning now to FIG. 5a, an example of a software demonstration having a branch condition is depicted. In the example of FIG. 5a, a user may be creating a software demonstration of a software application 522 having multiple options 524, 526, and 528. Each option 524, 526, and 528 may be used to access a feature and/or feature set of the application 522. An author of a software demonstration for application 522 may want to demonstrate each of the features 1 through N of the application 522.

To access feature 1 525 of the application, the software demonstration author may select option 1 input 524 of application 522 using pointer 540. Option 1 input 524 may comprise any input interface known in the art including, but not limited to, a button, a clickable area, a menu item, or the like.

Selecting option 1 input 524 may cause the application 522 to invoke application feature 1 525 as shown in FIG. 5b. As discussed above, a screenshot may be captured of application feature 525 responsive to the user input. Also as discussed above, the software demonstration authoring tool may provide the user a cue 550 indicating the timing of the screenshot capture. Although FIG. 5b shows only a single screenshot for application feature 1 525, it should be understood that, in order to fully demonstrate and/or explore the functionality of application feature 1 525, the author may need to capture multiple screenshots.

After completing the demonstration of application feature 1 525, the author may return to the main application 522 interface depicted in FIG. 5a to access other features of application 522.

Upon returning to the main application interface depicted in FIG. 5a, the author may select the option 2 input 526 of application 522. This may cause application feature 2 527 to be displayed as shown in FIG. 5c. As discussed above, this may cause the software demonstration authoring software to capture a screenshot showing feature 2 572. The software demonstration authoring software may provide a cue 550 to the user indicating the timing of the screenshot capture. Although FIG. 5c only shows a single screenshot associated with application feature 2 527, as discussed above, capturing the full functionality of application feature 2 may require multiple screen shots.

After fully capturing application feature 2 527, the user may return to the main application interface shown in FIG. 5a to access other features of the application 522 as desired. This process may be repeated for all N of the features of application 522.

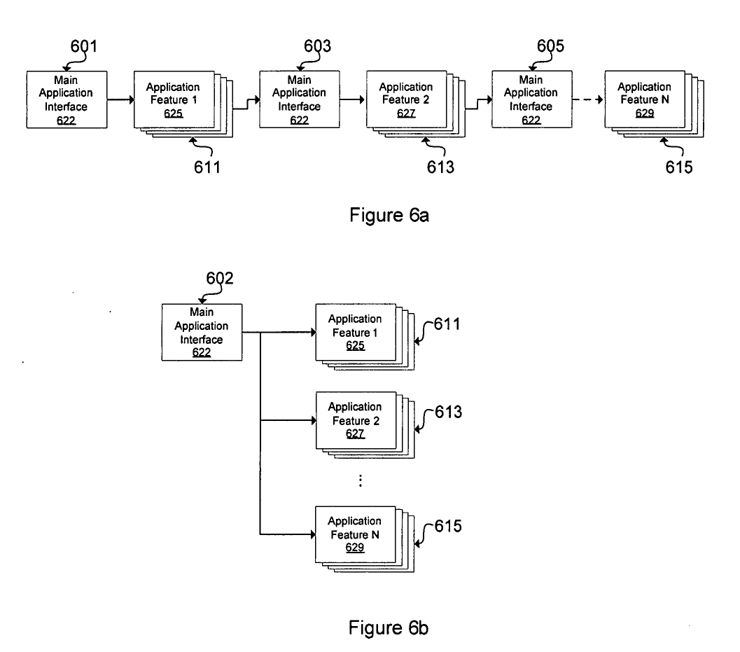

Turning to FIG. 6, the process of capturing each feature of an application 522 of FIG. 5a-5c may create a linear sequence of screenshots as depicted in FIG. 6a. FIG. 6a shows a linear sequential list of screenshots demonstrating each of the application features from application feature 1 625 through application feature N 629.

The linear sequential list depicted in FIG. 6a may be tedious for a software demonstration presenter to navigate. For example, if the presenter is demonstrating application feature N 629, and receives a question about application feature1 625, she would have to navigate back through all of the screenshots of application feature N and application feature 2 627 to get back to the screenshots showing application feature 1 625. This process may take a significant amount of time. Moreover, this type of linear navigation may take away from the authenticity of the software demonstration and disrupt the flow of the software presentation.

To remedy this situation and to allow the software demonstration author to create a natural looking demonstration that is simple to navigate, branching screenshots may be created. Turning to FIG. 6b, an example screenshot sequence using a branching screenshot is depicted. In this embodiment, a main branch screenshot 602 may be created, or merged, from each of the screen shots 601, 603, and 605. This may be done because each of screenshots 601, 603, and 605 are graphically similar and may be, as in the case of FIG. 5a-5c, identical. The only differences may be the location of the Hotspot used to advance to the following screenshot in the sequence and/or any hover effects. A branching screenshot 602 may be created from the multiple screenshots 601, 603, and 605 by combining the screenshot image into a single screenshot and combining the Hotspot and/or hover effects information in each screenshot into the branching screenshot. Thus, where a sequential screenshot 601, 603, 605 may comprise only one Hotspot and hover effect capable for forwarding the software demonstration, a branching screenshot 602 may comprise multiple Hotspots and hover effects, one per merged screenshot. In this embodiment, each Hotspot on branching screenshot 602 may advance the software demonstration to a separate branch of the software demonstration.

Turning now to FIG. 6b, a sequence of screenshots demonstrating multiple application features is depicted. As discussed above, screenshot 602 may be a branching screenshot created or merged from screenshots 601, 603, and 605. Accordingly, branching screenshot 602 may comprise a Hotspot from each of the merged screenshots 601, 603 and 605 (3 separate Hotspots). Each of the Hotspots of screenshot 602 may advance the software demonstration to a different application branch of the screenshot sequence. For example, the Hotspot merged into screenshot 602 from sequential screenshot 601 may advance the software demonstration to the screenshot sequence 611 showing application feature 1 625, the Hotspot merged into screenshot 602 from sequential screenshot 603 may advance the software demonstration to the screenshot sequence 613 showing application feature 2 627, and the Hotspot merged into screenshot 602 from sequential screenshot 605 may advance the software demonstration to the screenshot sequence 615 showing application feature N 629, and so on.

Upon creating the branching screenshot 602, each of the screenshots in application feature screenshot sequence 611, 613, and 615 may be modified. This modification may comprise providing an additional Hotspot on each branch sequence screenshot 611, 613, and 615, or only on the ending screenshot in each branch sequence 611, 613, and 615, to return the software demonstration to branching screenshot 602. This additional Hotspot may allow for easier and more lifelike navigation of the screenshot sequence since from any point in the sequence. In one embodiment, this additional Hotspot may be disposed on the “X” or “cancel” input of each application feature. In another embodiment, additional branching screenshots 602 may be inserted at the end of each sequence 611, 613, and 615. Upon selecting this additional Hotspot, the software demonstration may return to the root of the branch, the main application interface 622 depicted in screenshot 602, to allow the software demonstration presenter to navigate through other application features. In this way, the branching screenshot may allow a software demonstration to be easily navigated and may provide for more lifelike software demonstrations.

Returning to FIG. 5a, the software demonstration user interface may provide an input to allow the author to automatically create a branching screenshot. For example, the software demonstration tool may comprise an input key, such as the ‘home’ key or some other function-key combination to indicate that the current screenshot 512 is a branch screenshot. In the FIG. 5 example, the author may select this input key upon reaching the screenshot depicted in FIG. 5a. After selecting this input the user could select the appropriate option on the application 522 interface to invoke an application feature to demonstration (e.g., select option 1 524 to demonstration application feature 1 525 as shown in FIG. 5b). After capturing a screenshot sequence demonstrating the application feature, the user may return to the main application interface 522 shown in FIG. 5a. The user could then select the branching input (e.g., the ‘home’ key) to indicate that the screenshot is part of the branch. The software demonstration tool could then merge the current screenshot with the previously selected branching screenshot (e.g., the screenshot viewed before the author selected option 1 524). The screenshot disposed between the two screenshots may then be designated as a sequence branch associated with the original Hotspot. The author could then access option 2 526 to capture application feature 2 527, and so on. After capturing these additional application feature screenshots, the user may return to the main application interface 522. At this point the author may again select the appropriate input (e.g., the ‘home’ key), to indicate that the screenshot is part of the branch. Each branch created may be associated with its corresponding Hotspot, allowing the author to create a branching structure similar to that depicted in FIG. 6b.

This process for creating branch screenshots could be expanded where the software demonstration comprises multiple branches. In this embodiment, when the branch input is selected (e.g., the ‘home’ key), the user may be prompted to select a branch to merge with the current screenshot or to create a new branch. In this way, the demonstration author may create complex branching structures with nesting, all using the software as naturally as possible with minimal disruption.

Referring to FIG. 7, the software demonstration editing interface 700 (hereafter “editing interface”) may comprise a main window 702 comprising a menu bar 704. Menu bar 704 may comprise menu items typically found on software applications, such as a “file,” “help,” and the like.

Editing interface 700 may comprise a main window 706 which may be used to display a screenshot 712 captured during the software demonstration creation process described above. In another embodiment, main window 706 may be used to display thumbnail images of multiple screenshots comprising the entire software demonstration or a subset of the software demonstration. Screenshot 712 may comprise a Hotspot 775. Hotspot 775 may be automatically placed on screenshot 712 by the software demonstration authoring tool as described above. Using editing tool 700, an author may modify the position and shape of Hotspot 775. Hotspot 775 may define a “clickable area” within screenshot 712 which may be used to, inter alia, advance to the next screenshot in the software demonstration and/or invoke a hover effect. A clickable area as used herein may refer to an area of and/or the entire area of a screenshot or other user interface capable of responding to a pointing device. A clickable area may respond to a pointing device in a variety of different ways, including: producing a hover effect based on the pointer's proximity to the clickable area, or based on input, such as a button click of a pointing device. Various uses of Hotspot 775 are described in more detail below.

As discussed above, a branching screenshot may comprise multiple Hotspots defining multiple clickable areas. In a branching screenshot, each Hotspot and/or clickable area may advance the software demonstration to a different screenshot sequence. However, for clarity and simplicity, a standard screenshot comprising only a single Hotspot is depicted is FIG. 7.

Screenshot 712 may comprise click prompt 780. A click prompt 780 may be associated with each screenshot 712 in a software demonstration. As such, each screenshot 712 may comprise a different click prompt 780. Click prompt 780 may point to Hotspot 775, acting as a guide to a presenter of a software demonstration as to where Hotspot 775 is located. Click prompt 780 may comprise instructions to the presenter, such as “click here.” Editing interface 700 may allow the software demonstration author to input custom text into click prompt 780 to provide specialized instructions to the presenter. In one embodiment, click prompt 780 may comprise an audio or tactile cue to the presenter such that an audio cue or tactile feedback is given to the presenter when the pointer is proximate to Hotspot 775 and/or click prompt 780.

Editing interface 700 may comprise click-by-click instructions text entry box 765. Click-by-click instructions may be used to provide instructions to a presenter of the software demonstration. For instance, in the FIG. 7 example, the click-by-click instructions of text entry box 765 may instruct the presenter to, “click on the ‘Programs’ menu item” since the Hotspot 775 is located on the Programs menu item. Each screenshot 712 in a software demonstration may comprise its own click-by-click instructions entered via text entry box 765.

Editing interface 500 may comprise presenter script text entry box 770. A presenter script may be used to provide a presenter of the software demonstration with a script to follow during the software demonstration. Such a script may comprise key features of the product being demonstrated or any other information the author of the software demonstration wishes to convey through the demonstration. Each screenshot 712 in a software demonstration may comprise a separate presenter script entry entered via text entry box 770.

Editing interface 700 may comprise a panel 790 containing screenshot list 792 and button panel 794. Screenshot list 792 may display a list of all of the screenshots in the currently opened software demonstration. Screenshot list 792 may comprise a scrollable list and/or screenshot thumbnails images to facilitate the display and management of multiple screenshots. Screenshot list 792 may allow a user to remove, rearrange, and/or insert additional screenshots into a software demonstration. Screenshot list 792 may organize the screenshots of the software demonstration into modules, chapters, or sections for the convenience of user. Screenshot list 729 may show branching screenshots and their corresponding branch screenshot sequences. The editing functions of screenshot list 729 may allow the user to merge screenshots to create branching screenshots. Additionally, screenshot list 792 may be used to allow a user to specify which screenshots 792 should be included in a particular software demonstration, allowing the author to create multiple targeted software demonstrations from set of software demonstration screenshots.

Button panel 794 may comprise one or more buttons 795-799. Each of buttons 795-799 may perform a different operation on the software demonstration edited in editing interface 700. The operation of each button 795-799 shown on editing interface 700 is described below.

Button 795 may be used to display a preview of the software demonstration being edited in editing interface 700. In one embodiment, a preview mode software demonstration may comprise a watermark displayed on each screenshot indicating that the software demonstration is operating in “preview” or “sample” mode. Button 796 may be used to display the software demonstration being edited in editing interface 700.

When either option 795 or 796 is selected, editing interface 700 may be hidden from view and the software demonstration open in editing interface 700 may be displayed. In one embodiment, displaying a software demonstration comprises displaying one or more successive screenshots on a computer display. As discussed above, these screenshots may be displayed over the entire viewable area of a computer display or may be displayed over a portion of the viewable area of a computer display.

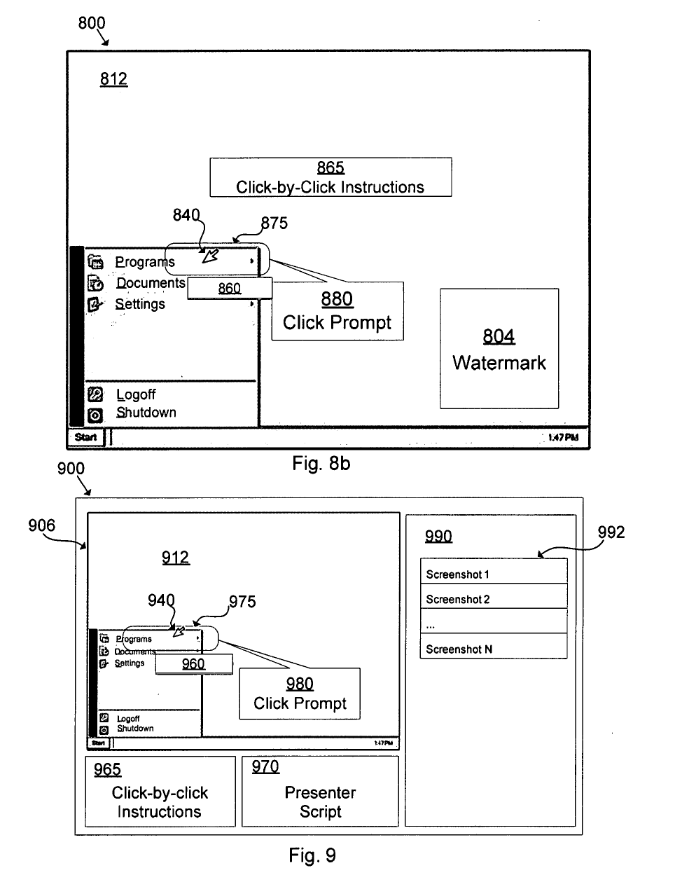

FIG. 8a depicts one embodiment of a block diagram of a software demonstration presentation application 821 running on a computer system 801. The computer system 801 may comprise a display 803 and pointer input device 805. Pointer input device 805 may comprise a mouse pointer or any other pointing and/or selection device known in the art including, but not limited to, a mouse, track ball, touch pad, optical input, tactile input, or the like. Computer system 801 may comprise a data storage system 807.

Computer system 801 resources 803, 805, and 807 may be controlled and/or managed by operating system 811. Operating system 811 may be any operating system known in the art including, but not limited to Microsoft® Windows, Solaris®, Linux, Unix®, Apple® OS X, or the like.

Presentation application 821 may run on computer 801. Presentation application 821 may comprise a software demonstration presentation application according to the teachings of this disclosure. Presentation application 821 may comprise an input detection component 823 and screenshot display and access component 825. Application 821 components 823 and 825 may access the resources of computer system 801 via an API provided by operating system 811.

The API provided by operating system 811 may allow input detection component 823 of application 821 to detect inputs to the computer 801 received via pointing device 805. The API may also allow authoring application 821 to determine the location and/or coordinates of the pointer of pointing device 805 on display 803. The API of operating system 811 may allow screenshot access and display component 825 of authoring application 321 to display screenshots of a software demonstration. Screenshot display and access component 825 may access screenshots from a software demonstration stored on storage system 809 of computer 801. Alternatively, screenshot display and access component 825 may access screenshot data from a source external to computer 801, such as a network storage location (not shown) and/or an external storage location (not shown). Screenshot display and access component 825 may display a screenshot over the entire viewable area of display 803 and/or may display a screenshot over a portion of the viewable area of display 803.

The software demonstration may advance through the screenshots comprising a software demonstration by detecting an input from pointing device 807 in a hotspot of the currently displayed screenshot. Alternatively, the screenshot may be advanced and/or rewound responsive to keyboard or other inputs to computer system 801. In addition, screenshot display and access component 825 may modify and/or replace the screenshot displayed on display 803 upon detecting that the pointer has entered the proximity of a hotspot of the currently displayed screenshot. This may allow application 821 to display hover effects associated with the screenshot.

FIG. 8b depicts one embodiment of a presentation of a software demonstration according to the teachings of this disclosure. In presentation or preview mode, a screenshot 812 may be displayed. It should be noted that although screenshot 812 may appear to be a “live” computer desktop, it is, in fact, not a fully-functional computer interface but a screenshot. As such, the software demonstrations created by the demonstration authoring tool of this disclosure need not be displayed on a computer capable of actually running the software to be demonstrated. The computer used for demonstration purposes need only be capable of displaying the screenshots and prompts described above. This may be desirable for presenters. For example, a complex network-based application may be demonstrated without requiring extensive setup or being connected to a network of any kind. Similarly, a computationally intensive application may be demonstrated on a lightweight computer. In addition, the software to be demonstrated may run on a different type of operating system and/or computer architecture than the computer used to present the demonstration.

In presentation or preview mode, screenshot 812 may be displayed as a standard desktop. In this mode, click-by-click instructions 865, Hotspot 875, and click prompt 880 may not be visible. As such, screenshot 812 may appear to an observer to be an actual “live” computer desktop. In addition, pointer 840 may be displayed over screenshot 812 and may be movable by a presenter over the entire area of screenshot 812. This may add to the realism of the software demonstration since the presenter is able to operate pointer 840 just as she would if she were using the “live” software.

As discussed above, when presenting a software demonstration in “preview mode,” watermark 804 may be displayed on each screenshot 812. Watermark 804 may comprise an image and/or text indicating that the software demonstration being displayed is in “preview” or “evaluation” mode. In one embodiment, watermark 804 may be prominently displayed so as to be immediately noticeable by an observer. When operating in “presentation mode,” watermark 804 may not be displayed. Additionally, in preview mode, the software demonstration may start from the currently selected screenshot rather than rewinding the software demonstration to the first screenshot. This may allow the author to quickly view the screenshot she is working on without navigating through the proceeding software demonstration screenshots.

During normal operation in either presentation or preview mode, click-by-click instructions 865 may be hidden from view. In one embodiment, an input (such as keeping the ‘tab’ key pressed) may be provided to cause click-by-click instructions 865 to be displayed. When visible, click-by-click instructions 865 may be displayed as a dialog box overlaying screenshot 812 as shown in FIG. 8. Click-by-click instructions 865 may be displayed only as long as the input key is depressed and may be removed from screenshot 812 when the input key is released. Alternatively, the input key may act as a toggle to switch between displaying and removing click-by-click instructions 865 from screenshot 812. In this way, click-by-click instructions 865 may be displayed only in the event a presenter requires the click-by-click instructions 865 to properly present the software demonstration.

During normal operation in either presentation or preview mode, click prompt 880 may be hidden from view. An input key (such as the ‘tab’ key or some other function-key combination) may be provided to a toggle, switching between displaying click prompt 880 on screenshot 812 and removing click prompt 880 from view. In this way, click prompt 880 may be displayed only in the event a presenter requires the click prompt 880 to properly present the software demonstration. Alternatively, in another embodiment, the input may be used to cause click prompt 880 to be temporarily displayed. In this embodiment, click prompt 880 may be displayed only as long as the input key is depressed and may be removed from screenshot 812 when the key is released.

Hotspot 875 may be displayed on screenshot 812. In one embodiment, Hotspot 875 may be displayed on screenshot 812 and may be used to define a “clickable area” on screenshot 812. As discussed above, a clickable area may be used to advance the software demonstration to a next screenshot In another embodiment, Hotspot 875 may be displayed temporarily based on user input. In this embodiment, although Hotspot 875 is shown as a rectangle overlaying screenshot 812 on FIG. 8, when in presentation or preview mode, Hotspot 875 may not be visible to the software demonstration presenter and/or observer. In one embodiment, however, Hotspot 875 may be temporarily displayed via a “shimmer” effect upon application of an input (such as a ‘alt’ or ‘ctrl’ key). When this input is applied, the Hotspot area 875 may be visually displayed on screenshot 812. Such display may comprise, graying out the area covered by Hotspot 875 on screenshot 812, displaying an outline of Hotspot 875 on screenshot 812, or the like. In another embodiment, this “shimmer” effect may be displayed as when a pointer control 840 enters the proximate area of Hotspot 875.

Hotspot 875 may be used to advance the software demonstration to a subsequent screenshot. As described above, a software demonstration according to the teachings of this disclosure may comprise one or more screenshots. The presenter may move from screenshot to screenshot and thusly demonstrate, via simulation, the operation of a software product. To move to a subsequent screenshot, the demonstration presenter may move pointer 840 into Hotspot 875 and apply the pointer input (e.g., click the mouse button). When the pointer input is applied within Hotspot 875, the software demonstration may advance to the next screenshot. If the pointer input is applied while pointer 840 is outside of Hotspot 875, the software demonstration may not advance to the next screenshot. In this way, the software demonstration may appear to be a live application responding to the presenter's inputs, creating a more realistic software demonstration.

As discussed above, a branching screenshot 812 may comprise multiple Hotspots with corresponding clickable areas, click prompts 880, shimmer effects, and/or hover effects 860. However, for simplicity, only a single Hotspot is depicted in FIG. 8.

In one embodiment, the software demonstration may also be navigated using a keyboard input. For example, the presenter may be able to advance the software demonstration to the next screenshot by either clicking a pointing device within Hotspot 8675 or by pressing an input key, such as the “right arrow” key. Similarly, a presenter may navigate to a preceding screenshot by pressing an input key, such as the “left arrow” key.

Returning to Hotspot 875 on screenshot 812, movement of pointer 840 into the screenshot 812 area defined by Hotspot 875 may cause a hover effect 860 to be displayed on screenshot 812. In an alternative embodiment, the hover effect may be displayed by replacing screenshot 812 with another screenshot comprising the captured hover effect(s). As discussed above, a hover effect may comprise a change to a menu item, the display of a tool-tip, or any other display, audio, or tactile display change occurring as pointer 840 selects a particular user interface component. In FIG. 8, a tool-tip hover effect 860 is displayed. However, it should be understood that any number of the described hover effects could be invoked either individually or in combination. For example, a hover effect may include tool-tip 860 and highlighting of a menu item, for instance, the “Programs” menu item in FIG. 8.

Turning now to FIG. 9, which depicts the presentation of a software demonstration in “training mode.” In addition to displaying a software demonstration in presentation and preview mode, a software demonstration according to the teachings of the present disclosure may also be displayed in training mode. In one embodiment, training mode may by invoked responsive to a user input, such as the ‘home’ key or some other function-key combination. In training mode, the software demonstration may be displayed as described above in conjunction with FIG. 9. In training mode, watermark may or may not be displayed depending on whether the demonstration is rendered in preview or presentation mode respectively. In FIG. 9, a watermark has been omitted from screenshot 912.

As discussed above, in training mode, a software presentation may be displayed as described above in conjunction with FIG. 8. However, training mode may provide an additional input key, such as the ‘home’ key, which may be used to toggle between the preview and presentation software demonstration presentation modes described above and training mode 900.

In FIG. 9, screenshot 912 may be placed in a display area 906 within training mode display 900. In one embodiment, screenshot 912 may be a scaled version of the screenshot shown in presentation or preview mode. Although not shown in FIG. 9, a watermark could be overlaid on screenshot 912. For example, a watermark should be overlaid of screenshot 912 if the software demonstration were being rendered in preview mode.

Hover effect 960 may be displayed in training mode display 900. In one embodiment, hover effect 960 may be constantly displayed in training mode display 900. In an alternative embodiment, hover effect 960 may be displayed upon application of an input to the software demonstration application. In this embodiment, the input may be the same as the input used in preview and/or presentation mode. Similarly, click prompt 980 and Hotspot 975 may be constantly displayed in training mode display 900 or may be displayed responsive to their respective inputs.

Training mode display 900 may comprise panel 990 containing screenshot list 992. Screenshot list 992 may display a list of all of the screenshots 912 in the software demonstration being viewed. As discussed above, the screenshot list 992 may be organized in various ways, including software demonstration modules, chapters, and/or sections. In one embodiment, only the modules, chapters, and/or sections selected by the author for upload may be included in screenshot list 992. However, by default, all of the screenshots in a particular software demonstration may be included in screenshot list 992.

Screenshot list 992 may comprise a scrollable list and/or screenshot thumbnail images to facilitate the display and management of multiple screenshots. In training mode, screenshot list 992 may be read-only, such that a user may be allowed to scroll through and view the screenshots contained within screenshot list 992, but may not be able to remove, rearrange, and/or insert any of the screenshots therein. In training mode, the user may skip to a particular screenshot within screenshot 992 by selecting the desired screenshot within screenshot list 992. In this way, a presenter may focus her attention on particular screenshots, such as those that are critical to the software demonstration and/or those the presenter is having a difficult time presenting.

In training mode display 900, click-by-click instructions text box 965 may be displayed. Click-by-click instructions text box 965 may be embodied as a read-only text display. As such, a user viewing the software demonstration in training mode may be able to read the click-by-click instructions text box 965, but may not be able to edit the click-by-click instructions text box 965.

In training mode display 900, presenter script 970 may be displayed. Presenter script 970 may be embodied as a read-only text display. As such, a user viewing the software demonstration in training mode may be able to read the presenter script text box 970, but may not be able to edit presenter script contained therein. In this way, a presenter may have access to the presenter script while viewing the presentation screenshot 912. This may allow a presenter to be trained on the presentation script and/or click-by-click instructions while observing the software presentation as it will be displayed in presentation or preview mode.

In one embodiment of training mode 900, an input may be provided to toggle between training mode display 900 and presentation and/or preview display 800. In this way, a presenter may practice presenting a software presentation in presentation mode and, in the event the presenter needs to review the presenter script and/or screenshot ordering, quickly switch to training mode display 900. Then, after the presenter has reviewed the required information, the presenter may switch back to presentation mode 800 by toggling the input. In this way, a software demonstration, according to the teachings of the present disclosure, may increase the efficiency of software demonstration presenter training.

As discussed above, while in training mode display 900, the software demonstration may respond to user input just as it does in presentation or preview mode 800. In particular, Hotspot 960 may be displayed when pointer 940 is positioned within Hotspot 975. The software demonstration may be advanced by selecting a pointer input within Hotspot 975, and the software demonstration may be advanced or regressed by selecting an appropriate input key (‘right’ or ‘left’ input keys).

Training mode 900 may be used to facilitate the training of a software demonstration presenter. This is because training mode 900 may allow the trainee to simultaneously view all of the information needed to present the software demonstration in a single interface: the screenshot, the Hotspot, click prompt, and presenter script. This may allow the trainee to learn the software demonstration while experiencing the software demonstration in a similar way the trainee will ultimately present it. Additionally, training mode 900 may allow the presenter to quickly switch between a training mode 900 view and a presentation mode view. This may allow the presenter to practice presenting the software demonstration as she will present it in a “live” environment, while retaining the ability to switch back to a training mode 900 view if required.

Returning now to FIG. 7, input 797 on software demonstration editing interface 700 may be used to publish a software demonstration for review. Upon selecting input 797, editing interface 700 may package the screenshots in screenshot list 792, click-by-click-instructions 765, presenter scripts 770 into a software demonstration capable of being uploaded to a network accessible storage location. In one embodiment, the package created by the editing tool may be capable of being viewed over a network, such as a local area network (LAN), wide area network (WAN), Internet, or the like. The package may comprise Hyper Text Markup Language (HTML) capable of being displayed in web browser software, such as Mozilla® Firefox, Microsoft® Internet Explorer, and the like. However, the package described herein should not be limited to only web technologies, but could comprise any storage and/or display technology known in the art.

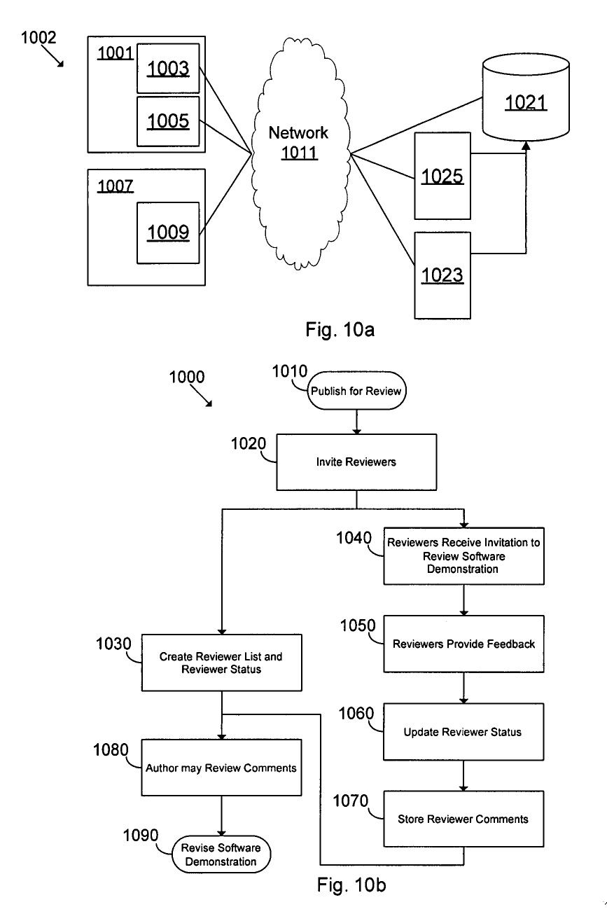

FIG. 10a depicts one embodiment of a block diagram of a system 1002 for facilitating collaboration on a software demonstration, or any other type of authored content. System 1002 may comprise a computing device 1001 running an authoring tool 1003. Authoring tool 1003 may comprise a software demonstration authoring tool according to the teachings of this disclosure.

Authoring tool 1003 may be configured to publish authored content generated using the tool 1003. The publishing may comprise uploading the content to a network accessible storage location 1021. This uploading may be done over a network 1011. Network 1011 may comprise the Internet, a wide area network (WAN), local area network (LAN), virtual local area network (VLAN), or any other network data communication system and/or architecture known in the art.

Network accessible storage location 1021 may store the content and make the content available via a reviewer interface 1023 and author interface 1023. A reviewer may access the authored content stored on network accessible storage location 1021 using a computing device 1007. Computing device may run a program 1009 capable of displaying the authored content. In one embodiment program 1009 may comprise web browsing software such as Mozilla Firefox®, Microsoft® Internet Explorer® or the like. Program 1009 may access the reviewer interface 1023 over network 1011. As will be discussed below, reviewer interface 1023 may allow the reviewer to view and/or comment on the authored content. The commentary provided by the reviewer may be stored in 1021 and may be associated with the authored content viewed and the submitting reviewer.

The author may access reviewer comments via author interface 1025. The author may access the author interface 1025 via network 1011 which, as discussed above, may comprise any network communication system known in the art. The author may access author interface 1025 using an application 1005 capable of displaying the author content. In one embodiment, application 1005 may comprise web browsing software. The author interface 1025 may allow the author to view the content along with any commentary entered by reviewers of the content.

Turning to FIG. 10b, which depicts a flow diagram for collaboration on a software demonstration under the teachings of the present disclosure. At step 1010, a software demonstration author may publish a software demonstration for review. This may be done as described above. In one embodiment, the software demonstration may be published via the Internet and made available via web browsing software. In this embodiment, the software demonstration may be made available via a portal-style website. The portal website may include a listing of software demonstrations uploaded by a particular author. The portal web interface may also allow the software demonstration author to manage and view reviews of her uploaded software demonstrations.

At step 1020, the software demonstration author may invite one or more entities to review the uploaded software demonstration. These reviewers may be selected from a contacts list similar to an email address book, or, alternatively, the entities may be manually entered by email address or some other identifier. If manual entry is used, the software demonstration author may be given the opportunity to include the reviewers in a contact list. At step 1020, the software author may specify a due date for each review. In one embodiment, step 1020 may be performed using the editing interface 500. In an alternative embodiment, step 1020 may be performed via a web portal interface.

At step 1030, a list may be generated at the web portal interface detailing the status of each reviewer invited to review the software demonstration uploaded at 1010. The list created at step 1030 may list each reviewer along with the time each reviewer accessed the software demonstration (if any) and whether the reviewer has completed her review. If a reviewer has not completed her review by a due date specified at step 1020, send a reminder message may be sent to the reviewer. The status list generated at step 1030 may show whether such a reminder message has been sent and whether any response to the message has been received.

At step 1040, each reviewer invited at step 1020 may be sent an invitation message to review the software demonstration uploaded at step 1010. This invitation message may comprise an email containing a link to the web portal hosting the demonstration to be reviewed along with instructions on how to perform a review. The message may comprise two separate links allowing the recipient to either accept or decline the invitation to review the software demonstration. The status of the reviewer's acceptance may be reflected in the list generated at step 1030. If the reviewer declines the invitation, the review may be removed from the list generated at step 1030.

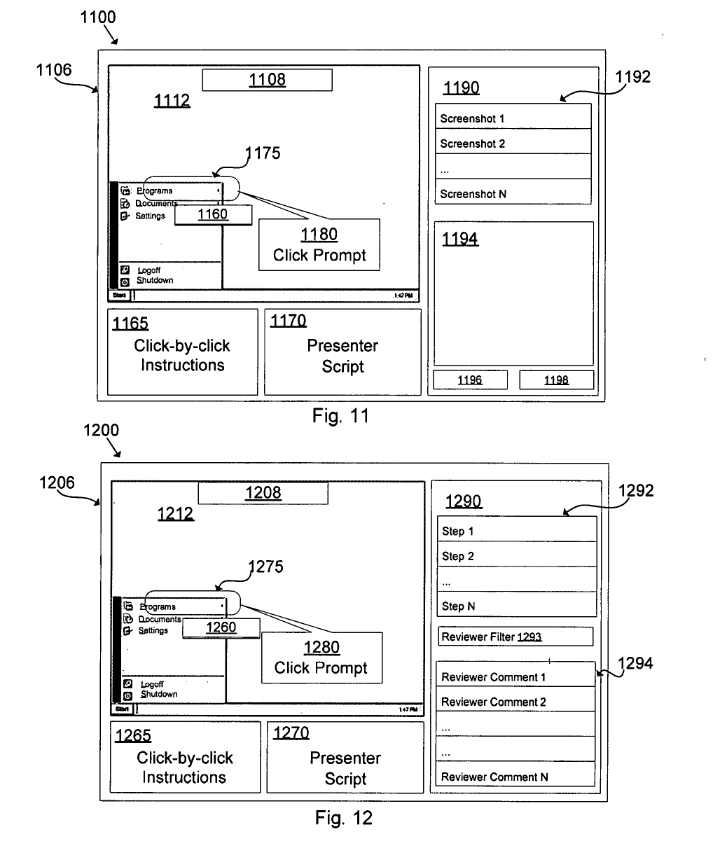

At step 1050, the reviewers who accepted the invitation sent at 1040 may access and review the software demonstration. The interface used to submit such a review is described below in conjunction with FIG. 11.

At step 1060, the reviewer status list created at step 1030 may be updated to show that the reviewer has competed her review. In one embodiment, the message may include the comments provided by the reviewer. Additionally, if all of the reviews are completed, a message may be dispatched to the software demonstration author alerting her that all of the reviewers have completed their reviews, this message may include all of the reviews submitted by the reviewers.

At step 1070, the reviewer's comments may be stored and associated with the software demonstration uploaded at step 1010. When completed, the reviewer's comments may be stored in the software demonstration package uploaded at step 1010, or, alternatively, the web portal hosting the software demonstration may store the reviewer's comments in a separate storage location, such as a relational database, X.509 directory, or any other data storage and retrieval system known in the art.

At step 1080, the software demonstration author may access the reviewer list created at 1030 to access the reviewer comments submitted at step 1050 and stored at step 1070. The author may access reviewer comments through an interface, such as the interface depicted in FIG. 12.

At step 1080, the software demonstration author may revise the software demonstration as desired taking into account the reviewer comments received at step 1080. The revisions of step 1090 may be made using the editor interface, such as that depicted in FIG. 7.

FIG. 11 depicts one embodiment of a web interface displaying a software demonstration packaged for on-line review. Reviewer interface 1100 may comprise a web interface adapted for use with web browser software. As such, the resolution of each screenshot 1112 may be reduced from its full resolution to reduce bandwidth and storage requirements.

The software demonstration reviewer interface 1106 may be embedded within a web browser software and, as such, may be capable of being displayed on a wide variety of devices including personal computing devices, cellular telephones, personal digital assistants (PDA), or the like. As such, user interface 1106 may be adapted for use on a particular user device. For instance, a first user interface may be presented if a user is accessing the reviewer interface 1106 using a personal computing device and a second user interface may be presented if a user is accessing the reviewer interface 1106 using a mobile computing device. The embodiment of FIG. 11 may represent a reviewer interface 1106 adapted for use through web browser software running on a personal computing device.

The software demonstration reviewer interface 1100 may comprise a navigation component 1108 which may facilitate the reviewer's traversal from screenshot 1112 to screenshot 1112. As such, navigation component 1108 may comprise forward and reverse user interface components which, when selected, may cause the software demonstration to move forwards or backwards through the software demonstration screenshots 1112.

Each software demonstration screenshot 1112 may display hover effect(s) 1160, Hotspot 1175, and click prompt 1180. Since the software demonstration is being displayed as an interactive webpage, automatically displaying these effects may facilitate the reviewer's interaction with the demonstration since it may not be feasible nor efficient to capture user inputs to toggle the display of hover effects(s) 1160, Hotspot 1175, and click prompt 1180. However, as more interactive web technologies become available, it may be more feasible to cause Hotspot 1175, click prompt 1180, and hover effect 1160 to behave as in presentation, preview, and/or training mode.

Software demonstration reviewer interface 1100 may comprise a read-only text area click-by-click instructions 1165 and read-only text area presenter script 1170. As discussed above, each screenshot 1112 may have its own click-by-click instructions text area 1165 and presenter script text area 1170. Reviewer interface 1100 may allow for review of each click-by-click instructions and presenter script associated with each screenshot 1112.

Software demonstration reviewer interface 1100 may comprise panel 1190 containing screenshot list 1192, comment entry 1194, and input buttons 1196 and 1198. Screenshot list 1192 may display a list of all of the screenshots in the software demonstration to be reviewed in a scrollable list. Screenshot list 1192 may allow the reviewer to navigate through the screenshots in the software demonstration by selecting a screenshot from screenshot list 1192. As discussed above, screenshot list 1192 may organize the screenshots of the software demonstration into screenshot modules, chapters, and sections as appropriate.

Comment entry 1194 may comprise a text entry component configured to receive the reviewer's comments. Each screenshot 1012 may have a separate comment entry component 1194. This may allow a reviewer to comment on each screenshot 1112 individually. Since all of the software demonstration components associated with a particular screenshot 1112 are displayed in the reviewer interface 1100, the reviewer may comment on any of the screenshot 1112, Hotspot 1175, hover effect(s) 1160, click prompt 1180, click-by-click instructions 1165, and/or presenter script 1170. In one embodiment, review entry component 1194 may comprise separate entry fields for each of the above components displayed on reviewer interface 1100.

Buttons 1196 and 1198 may be disposed on panel 1190 of software demonstration reviewer interface 1100. Buttons 1196 and 1198 may be mapped to a variety of different functions. In one embodiment, button 1196 may allow reviewer comments to be saved to allow the reviewer to continue reviewing the software demonstration at a later time. In this embodiment, the reviewer may review one or more screenshots 1112, save her comments, and then return to complete the review at a later time without having to re-enter her earlier submitted comments. Button 1198 may allow a reviewer to submit her review after she has finished reviewing each of the screenshots in screenshot list 1192.

Turning now to FIG. 12, an embodiment of a web interface for displaying a software demonstration with reviewer comments is depicted. Like the reviewer interface 1200 of FIG. 12, interface 1200 may comprise a web interface adapted for use with web browser software. As such, the resolution of each screenshot 1212 may be reduced from its full resolution to reduce bandwidth and storage requirements.

The reviewer comment interface 1206 may be embedded within a web browser software and, as such, may be capable of being displayed on a wide variety of devices including personal computing devices, cellular telephones, PDAs, or the like. As discussed above, the reviewer comment interface 1206 may be adapted for use on a particular user device. The embodiment of FIG. 12 may represent a reviewer comment interface 1206 adapted for use through web browser software running on a personal computing device.

Reviewer comment interface 1200 may display screenshots 1212, navigation control 1208, hover effect(s) 1260, click-by-click instructions 1265, presenter script 1270, Hotspot 1275, click prompt 1280, and screenshot listing 1292 in substantially the same way these components are displayed in reviewer interface 900.

Reviewer comment interface 1200 may comprise reviewer comment display component 1294. Reviewer comment display component 1294 may list each of the review comments submitted through reviewer interface 1100 for a particular screenshot 1212. As discussed above, each screenshot 1212 may be independently reviewed. As such, each screenshot 1212 may be associated with a separate reviewer comment display component 1294. This may aid the author in associating reviewer comments with the features of a particular screenshot 1212. The author may view all of the comments associated with each screenshot 1212 in a particular software demonstration by navigating through screenshots 1212 using navigation component 1208 and/or screenshot list 1292. In one embodiment, reviewer comment interface 1200 may comprise reviewer filter control 1293. Reviewer filter control 1293 may comprise a list including each of the reviewers invited to comment on the software demonstration. The author may use reviewer filter control 1293 to select one or more reviewers from the list and, responsive to the selection, only the comments of the selected reviewers may be displayed in the review comment display 1294.

In one embodiment of reviewer comment interface 1200, click-by-click instructions text box 1265 and presenter script 1270 may be editable to allow the author to quickly integrate the reviewer comments in reviewer comment display component 1294 into the software demonstration. The changes entered into reviewer comment interface 1200 may be downloaded into the editor interface 700 used to create the software demonstration depicted in FIG. 7.

Returning to FIG. 7, input 796 on editing interface 700 may be used to publish a software demonstration for download. Publishing a software demonstration for download may cause the editing interface to package the screenshots 712, hover effects 760, click-by-click instructions 765, presenter scripts 770, Hotspots 775, and click prompts 780 into one or more files. The file(s) may comprise additional software to allow the recipient of the package to play back the software demonstration, edit the demonstration, and create new software demonstrations according to the teachings of this disclosure. In one embodiment, the software package may comprise “trial” versions of the editing and creation software meaning that some of the functionality may be disabled and/or modified from the behavior of a “full” version. The distribution of the software demonstration editing and authoring software is discussed in more detail below. The player software distributed in the package may allow the software demonstration to be installed and played on various computing devices. Such computing devices may include, but are not limited to: a personal computer, a cell phone, a PDA, or the like. The resulting installable package may be uploaded to a web-accessible storage location for distribution. As in the method described in conjunction with FIG. 8, after uploading the installable package, the author may specify one or more contacts to send an invitation message. The contacts may be pre-stored and selected from an address book style interface or may be manually entered. The invitation message may direct the recipient to the network-accessible storage location where the installable package may be downloaded. In one embodiment, the software author may specify that only invited contacts may be allowed to access the software demonstration.

Input 798 of FIG. 7 may be used to publish a software demonstration for distribution. As described above, publishing a software demonstration for distribution may comprise causing the editing interface to package the screenshots 712, hover effects 760, click-by-click instructions 765, presenter scripts 770, Hotspots 775, and click prompts 780 into a single file. This file may comprise player software capable of displaying the software demonstration on a computing device. However, unlike the process described above, the file may not be automatically published on a network-accessible storage location. Instead, the file may be stored on the author's computer (or some other file storage location accessible to the author). The author may then distribute the file as desired.

As discussed above, in one embodiment, the single file generated via inputs 796 and/or 798 may further comprise a trial edition of the software demonstration editing and authoring program. Thus, in addition to distributing the software demonstration and viewing program, recipients of the file may also obtain a trial version of the demonstration authoring program. The trial version of the editing and authoring program may have a modified and/or reduced feature set than the corresponding full version. For example, the trial version of the editor may allow a user to view software presentations in preview mode only. In this embodiment, the trial software may allow a user to experience the basic editing and authoring features of the software without allowing the user to fully utilize the software for commercial purposes. As such, the user may be induced to purchase a full version of the software. In this way, trial versions of the software demonstration may be distributed virally among authors, presenters, and recipients of software demonstrations created according to the teachings of this disclosure.

In another embodiment, the file generated via inputs 786 and/or 789 may comprise a fully-functional version of the editing and authoring software. As discussed above, this may allow the recipient of the software demonstration to modify and/or adapt the software demonstration to fit her needs. It may also allow the recipient to create new software demonstrations. Also as discussed above, this distribution method may virally spread the software editing and authoring tool to users, allowing those users to become acquainted with the product, creating marketing opportunities for the software demonstration editing and authoring tool.

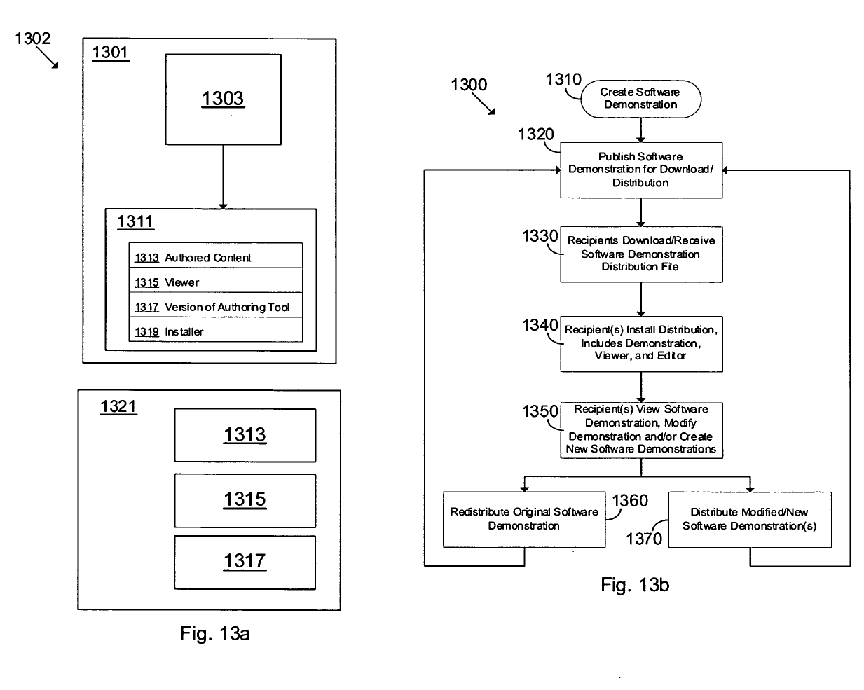

FIG. 13a depicts an embodiment of a block diagram of a system 1302 that may be used to virally create marketing opportunities for an authoring tool 1303. System 1302 may comprise a computing device 1301 running an authoring tool 1303. Authoring tool 1303 may comprise a software demonstration authoring tool according to the teachings of this disclosure.

The authoring tool 1303 may be configured to publish authored content into a distributable file 1311. The distributable file 1311 created by authoring tool 1303 may comprise the authored content 1313. The file 1311 may also comprise a viewer to allow a recipient of the file 1311 to view the authored content. File 1311 may also comprise a version of the authoring tool 1317. The version of the authoring tool 1317 included in the distributable file 1311 may be a trial and/or unlicensed version of the authoring tool used to generate the authored content 1313 and/or published the authored content 1313 in the distributable file 1311. The version of the authoring tool 1317 in file 1311 may be a full version of the authoring tool 1303. Finally, file 1311 may comprise an installer 1319 configured to install all of the authored content 1313, viewer 1315, and version of the authoring tool 1317 in a single step.

A recipient of a copy of the distributable file 1311 may install the file 1311 on a computing device 1321. Invoking the installer 1319 of the distributable file may cause the authored content 1313, viewer 1315, and version of the authoring tool 1317 to be installed on the computing device 1321. These installs may be performed in a single install step.

Turning now to FIG. 13b, a flow diagram of a viral marketing method for software demonstrations according to the teachings of this application is depicted. At step 1310, an author may create a software demonstration using the creation and editing interfaces described herein. At step 1320, the author may publish the software demonstration either to a web portal for download or to a file system for manual distribution.

At step 1330, the invitees of the author may download the software demonstration for a web-accessible storage location and/or the author may directly distribute the software demonstration to one or more recipients.

At step 1340, the recipients of the software demonstration may install the software demonstration distribution file. As described above, the software demonstration distribution file may comprise the software demonstration assets to be displayed, player software for displaying the software on a computing device, and a trial and/or or licensed version of the editing and authoring software for modifying and/or creating new software demonstrations. As such, when the recipient installs the software demonstration at step 1340, each of these components may be installed on the recipient's computing device without any additional downloads or other steps. If a trial or full featured version of the software demonstration editing/creation software is already installed on the recipients computing device, the trial editing software may not be installed.

At step 1350, the recipient may view the demonstration using the player installed at step 1340. After viewing the software demonstration, the recipient may access the trial version of the editing software installed at step 1340 to modify the demonstration or create one or more new software demonstrations. As discussed above, a trial editing/authoring software installed at step 1340 may be limited in its functionality. For example, the collaboration and distribution features of the software demonstration authoring tool may be disabled. When such limits are encountered, the recipient may be prompted to upgrade to a full version of the product, creating a marketing opportunity for the software demonstration editing/creation tool. Alternatively, if a full version of the editing/authoring software was included at step 1340, the user may be induced to obtain training, support, service, additional licenses, or the like, which may create additional marketing opportunities.

At step 1360, the recipient of the software demonstration distribution file obtained at step 1330 may redistribute the distribution file received at step 1330 to colleagues and/or other users. As in step 1340, each of the recipients will obtain a trial version of the software demonstration editing/creation tool which may create additional marketing opportunities for the software demonstration editing/creation tool.

At step 1370, the recipient of the software demonstration distribution file may modify and/or create a new software demonstration using the full version of the software demonstration tool. In this embodiment, the publish feature may be disabled in the trial version of the software. The resulting modified and/or new software demonstration distribution files may be published as in step 1320 and distributed as in step 1330. Each of the recipients of any modified and/or new software demonstrations will install the trial version of the software demonstration tool, creating still more additional marketing opportunities for the software demonstration editing/creation tool. Recipients of any redistributed 1360, modified, and/or new software 1370 demonstrations may recursively continue the viral distribution/marketing process at step 1320.

It will be obvious to those having skill in the art that many changes may be made to the details of the above-described embodiments without departing from the underlying principles of the invention. The scope of the present invention should, therefore, be determined only by the following claims.

I claim:

1. A method of authoring a software demonstration comprising a first screenshot on a computer having a display, comprising:
providing for detecting a user input;
providing for automatically acquiring a second screenshot after a user-configurable delay period to allow the computer to refresh the display responsive to the user input; and
providing for providing a cue to the user to inform the user of the timing of the second screenshot.

2. The method of claim 1, further comprising providing for defining a first clickable area within the first screenshot corresponding to a position of a pointer on the display at the time of the detecting of the user input.

3. The method of claim 2, further comprising providing for linking the first screenshot to the second screenshot.

4. The method of claim 3, wherein the first screenshot and second screenshot are linked using the first clickable area.

5. The method of claim 2, further comprising providing for replacing the second screenshot with a third screenshot, wherein the replacing removes the second screenshot from the software demonstration and links the first screenshot to the third screenshot using the first clickable area.

6. The method of claim 1, further comprising providing for acquiring a third screenshot, wherein the third screenshot is linked to the second screenshot using a clickable area of the second screenshot.

7. The method of claim 1, further comprising providing for acquiring a third screenshot, wherein the third screenshot is linked to the first screenshot using a second clickable area of the first screenshot.

8. The method of claim 1, wherein the second screenshot comprises an entire viewable area of the display.

9. The method of claim 1, wherein the second screenshot comprises a portion of a viewable area of the display.

10. The method of claim 2, wherein the cue comprises a visual effect on the display.

11. The method of claim 10, wherein the visual effect is overlays the pointer.

12. The method of claim 1, wherein the cue comprises an audio prompt.

13. The method of claim 1, wherein the cue comprises a tactile prompt conveyed through an input device of the computer.

14. An article of manufacture for authoring a software demonstration having a first screenshot on a computer, comprising:
a machine-readable medium having instructions stored thereon to:
detect a user input;
delay a pre-determined time period to allow the computer to refresh the display responsive to the user input; and
automatically acquire a second screenshot after the delay, wherein the acquiring comprises providing a cue to inform the user of the timing of the acquiring.

15. The article of manufacture of claim 14, wherein the pre-determined time period is user-configurable.

16. The article of manufacture of claim 14, wherein to detect a user input comprises detecting a pointer input.

17. The article of manufacture of claim 16, wherein the instructions are further to define a first clickable area on the first screenshot corresponding to a position of the pointer on the display at the time of the detecting a user input.

18. The article of manufacture of claim 17, wherein the instructions are further to link the first screenshot to the second screenshot in the software demonstration using the first clickable area.

19. The article of manufacture of claim 18, wherein the instructions are further to replace the second screenshot with a third screenshot, wherein to replace is to remove the second screenshot from the software demonstration and to link the first screenshot to the third screenshot using the first clickable area.

20. The article of manufacture of claim 18, wherein the instructions are further to automatically acquire a third screenshot and to link the third screenshot to the first screenshot using a second clickable area on the first screenshot.

21. The article of manufacture of claim 18, wherein the instructions are further to automatically acquire a third screenshot and to link the third screenshot to the second screenshot using a second clickable area on the second screenshot.

22. The article of manufacture of claim 14, wherein the cue comprises a visual effect on the display.

23. The article of manufacture of claim 14, wherein the computer comprises an audio output and the cue comprises an audio prompt.

24. The article of manufacture of claim 14, wherein the computer comprises an input device and the cue comprises tactile feedback through the input device.

25. A system for authoring a software demonstration having a first screenshot, comprising:
a computer having a display and a pointer input;
an input detection module to detect a pointer input and to define a first clickable area corresponding to the position of the pointer on the display upon the detecting;
a screen capture module to capture a second screenshot of the display responsive to the detecting after a user-configurable delay period; and
a screenshot ordering module to associate the first clickable area with the first screenshot and to link the second screenshot to the first screenshot using the first clickable area within the software demonstration, wherein the screenshot ordering module is configured to replace the second screenshot with a third screenshot responsive to a user input, and wherein the replacing comprises removing the second screenshot from the software demonstration and linking the first screenshot to the third screenshot using the first clickable area.

26. A method for presenting a realistic software demonstration on a first computing device having a display and a pointer input device, the software demonstration comprised of a plurality of screenshots depicting an operating state of a second computer system, the method comprising:
providing for displaying a first screenshot of the software demonstration, wherein the screenshot covers substantially all of a viewable area of the display;
providing for displaying a pointer controlled by the pointer input device capable of moving freely over the first screenshot; and
providing for providing a first clickable area on the first screenshot, wherein a pointer input received in the first clickable area causes the software demonstration to display a second screenshot, and wherein proximity of the pointer to the first clickable area causes a hover effect to be displayed, wherein the hover effect corresponds to an operating state of the second computer system.

27. A method for facilitating collaboration on a software demonstration comprising a plurality of screenshots created by an author using an authoring tool, the method comprising:
providing for automatically publishing the software demonstration to a network accessible storage location from the authoring tool;
providing for displaying a first screenshot of the software demonstration in a reviewer interface, the reviewer interface comprising a commentary input, wherein commentary entered therein by a reviewer is stored and associated with the first screenshot and the reviewer; and
providing for displaying the first screenshot in an author interface, the author interface comprising a commentary display to display commentary associated with the first screenshot, wherein each displayed commentary entry is associated with a reviewer.

28. A method to virally create marketing opportunities for an authoring tool used to create and publish authored content, the method comprising:
providing for publishing authored content into a single distributable file, wherein the distributable file comprises the authored content, a viewer capable of displaying the authored content on a computing device, and a version of the authoring tool used to create the authored content; and
providing an installer to install each of the authored content, viewer, and version of the authoring tool on a computing device to allow a receiver of the distributable file to install the authored content, viewer, and version of the authoring tool in a single install step.
